(19) United States
(12) Patent Application Publication
(10) Pub. No.: US 2022/0167765 A1
(43) Pub. Date: Jun. 2, 2022

(54) Mugs with Thermochromatic Paint

(71) Applicant: A Day Apart Pty Ltd., Caloundra (AU)

(72) Inventors: Kathleen May Ruddy, Golden Beach (AU); Nicole Marie Dingle, Wurtulla (AU)

(21) Appl. No.: 17/109,995

(22) Filed: Dec. 2, 2020

(51) Int. Cl. A47G 19/22; G01K 11/12

(52) U.S. Cl. CPC A47G 19/2227; A47G 2019/225; G01K 11/12

(57) ABSTRACT

A set of mugs has at least three mugs, each of the at least three mugs having a first printing and a second printing. The second printing is of thermochromatic paint which is positioned to selectively obscure the first printing at room temperature. The second printing is identical on each of the at least three mugs, and the first printing is not visible, so that the at least three mugs cannot be distinguished from each other when the at least three mugs are at room temperature. Each of the at least three mugs has a different indicia formed by the first printing, the first printing being visible when the at least three mugs are at an elevated temperature and the thermochromatic paint of the second printing is transparent.

### BACKGROUND OF THE INVENTION

### Field of the Invention

This invention relates generally to thermochromatic dishes, and more particularly to mugs with thermochromatic paint that fades to reveal non-heat-sensitive paint.

### Description of Related Art

Thermochromatic paint is typically applied to items such as t-shirts and dishes in the form of visual designs, either appearing as the item is raised to an elevated temperature, or disappearing to reveal a non-heat-sensitive print underneath. The prior art typically provides designs which are ornamental or humorous.

The prior art teaches thermochromatic paint layered over a non-heat-sensitive print in the form of visual designs and indicia. However, the prior art does not teach a set of mugs with thermochromatic paint wherein each of the mugs may be raised to an elevated temperature to reveal a unique answer to a given question. The present invention fulfills these needs and provides further advantages as described in the following summary.

### SUMMARY OF THE INVENTION

The present invention teaches certain benefits in construction and use which give rise to the objectives described below.

The present invention provides a set of mugs comprising at least three mugs, each of the at least three mugs having a first printing and a second printing. The second printing is of thermochromatic paint which is positioned to selectively obscure the first printing at room temperature. The second printing is identical on each of the at least three mugs, and the first printing is not visible, so that the at least three mugs cannot be distinguished from each other when the at least three mugs are at room temperature. Each of the at least three mugs has a different indicia formed by the first printing, the first printing being visible when the at least three mugs are at an elevated temperature and the thermochromatic paint of the second printing is transparent.

A primary objective of the present invention is to provide a set of mugs having advantages not taught by the prior art.

Another objective is to provide a set of mugs having a first printing and a selectively transparent second printing.

A further objective is to provide a set of mugs wherein each of the mugs may be raised to an elevated temperature to reveal an answer to a given question.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a set of mugs and a packaging box according to one embodiment of the present invention, the mugs being shown at room temperature with a second printing visible;

FIG. 2 is a perspective view of the set of mugs at an elevated temperature, revealing a first printing on each;

FIG. 3 is a perspective view of a set of mugs and a packaging box according to a second embodiment of the present invention, the mugs being shown at room temperature with a second printing visible; and

FIG. 4 is a perspective view of the set of mugs at an elevated temperature, revealing a first printing on each.

### DETAILED DESCRIPTION OF THE INVENTION

The above-described drawing figures illustrate the invention, a set of mugs having thermochromatic paint that are configured so that each mug in the set reveals a unique indicia when hot liquid is added to the mug.

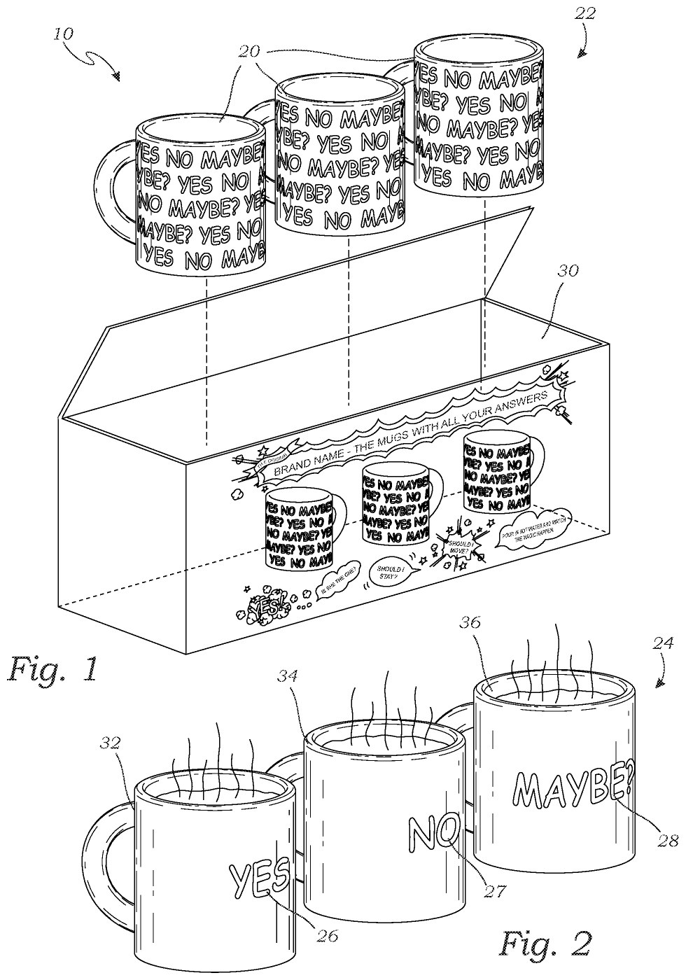

FIG. 1 is a perspective view of a set of mugs and packaging box 10 according to one embodiment of the present invention, being shown at room temperature with a second printing 22 visible. As shown in FIG. 1, the set of mugs 10 comprises at least three mugs 20 and a packaging box 30 sized and shaped to hold the at least three mugs 20 as an associated set. In this embodiment, there are exactly three mugs 20 each having a unique first printing 24 and the identical second printing 22, but any greater number of mugs 20 may be provided, as discussed below. For the purposes of this application, the terms “mug,” and “set of mugs,” may refer to any drinking container capable of functioning as described herein, and may or may not have a handle, lid, or further structures or ornamentation. The mugs 20 may be generally cylindrical in shape and may be constructed of earthenware or equivalent material, but alternatively may be constructed of any suitable known material in the art.

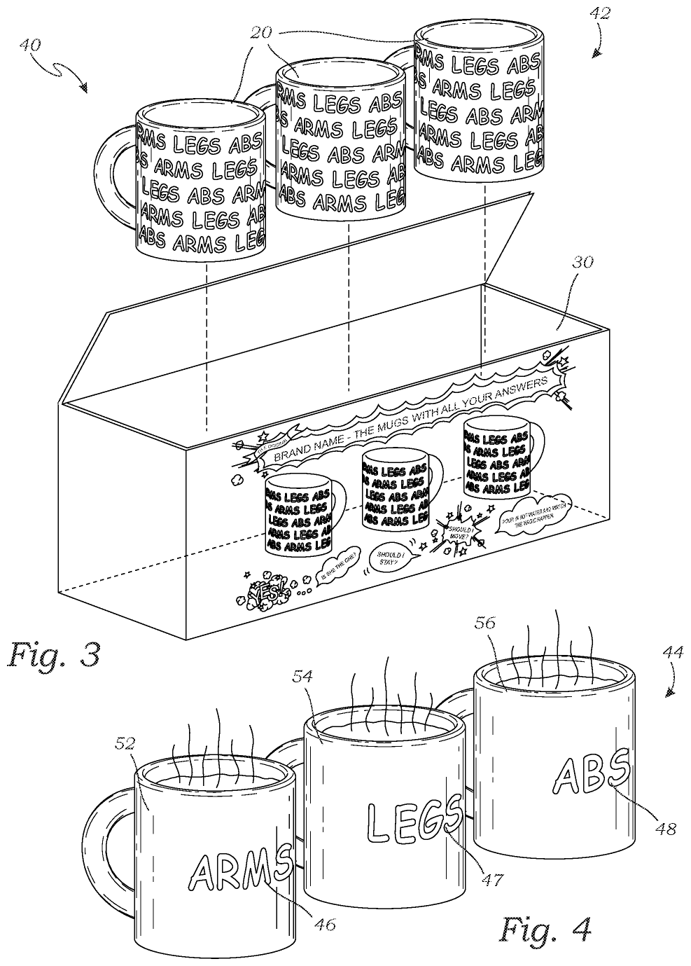

As shown in FIG. 1, the second printing 22 is of thermochromatic paint which is positioned to selectively obscure the first printing 24 at room temperature or cooler. When at room temperature (as when in the packaging box 30), the second printing 22 is identical on each of the at least three mugs 20, and the first printing 24 is not visible, so that the at least three mugs 20 cannot be distinguished from each other. In this embodiment, the second printing 22 is in the form of indicia that repetitively reads “YES NO MAYBE?”. However, in other embodiments, other words/phrases or symbolism may be used, including in languages other than English, as determined by potential questions they may answer. An alternative example of indicia 22 is shown in FIGS. 3-4 and discussed below. When the mugs 20 are raised to an elevated temperature (i.e., when containing hot liquid, when microwaved, in direct sunlight, from body heat, etc.), the first printing 24 will be visible, as shown in FIG. 2 and discussed below.

FIG. 2 is a perspective view of the three mugs 20 at an elevated temperature, revealing the first printing 24 on each. As shown in FIG. 2, each of the at least three mugs 20 has a different indicia 26, 27, or 28 formed by the first printing 24, the first printing 24 being visible when the at least three mugs 20 are at an elevated temperature and the thermochromatic paint of the second printing 22 is transparent. The first printing 24 on each of the three mugs 20 may typically be in the form of an “answer” to a question asked prior to raising one of the mugs 20 to an elevated temperature.

In this embodiment, the indicia 26 of the first printing 24 formed on a first mug 32 of the at least three mugs 20 is yes, the indicia 27 of the first printing 24 formed on a second mug 34 of the at least three mugs 20 is no, and the indicia 28 of the first printing 24 formed on a third mug 36 of the at least three mugs 20 is maybe. Any conceivable yes-or-no questions may be “asked” prior to heating one of the mugs 20 of the present embodiment, by an individual for personal purposes, or by group at a meeting or other event. As discussed above, alternative or additional “answers” may be included in the set of mugs 10, e.g., “try again,” “definitely,” “sometimes,” etc., or answers including other categories such as chores around the house, meals to cook, or any other category of answers that may be desired by the consumer. One alternative example is shown in FIGS. 3-4 and discussed below.

FIG. 3 is a perspective view of a set of mugs and a packaging box 40 according to a second embodiment of the present invention, the mugs 20 being shown at room temperature with a second printing 42 visible. FIG. 4 is a perspective view of the three mugs 20 at an elevated temperature, revealing a first printing 44 on each. As shown in FIGS. 3-4, an indicia 46 formed on a first mug 52 of the at least three mugs 20 is arms, an indicia 47 formed on a second mug 54 of the at least three mugs 20 is legs, and an indicia 48 formed on a third mug 56 of the at least three mugs 20 is abs, which may indicate to the user which area of the body he or she wishes to stretch/exercise/etc. The mugs 20 may also be more specific to target specific muscles or muscle groups, e.g., “quads,” “gluts,” etc., and, obviously, any other desirable answer.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A set of mugs comprising:
at least three mugs, each of the at least three mugs having a first printing and a second printing, the second printing being of thermochromatic paint which is positioned to selectively obscure the first printing at room temperature;
wherein the second printing is identical on each of the at least three mugs, and the first printing is not visible, so that the at least three mugs cannot be distinguished from each other when the at least three mugs are at room temperature; and
wherein each of the at least three mugs has a different indicia formed by the first printing, the first printing being visible when the at least three mugs are at an elevated temperature and the thermochromatic paint of the second printing is transparent.

2. The set of mugs of claim 1, wherein the indicia of the first printing on each of the at least three mugs is in the form of an “answer” to a question asked prior to raising one of the mugs to an elevated temperature.

3. The set of mugs of claim 1, wherein the indicia of the first printing on each of the at least three mugs is different from each other.

4. The set of mugs of claim 1, wherein the indicia of the first printing formed on a first mug of the at least three mugs is yes, wherein the indicia of the first printing formed on a second mug of the at least three mugs is no, and wherein the indicia of the first printing formed on a third mug of the at least three mugs is maybe.

5. The set of mugs of claim 1, wherein the indicia of the first printing formed on a first mug of the at least three mugs is arms, wherein the indicia of the first printing formed on a second mug of the at least three mugs is legs, and wherein the indicia of the first printing formed on a third mug of the at least three mugs is abs.

6. The set of mugs of claim 1, further comprising a packaging box sized and shaped to hold the at least three mugs as an associated set.
